(19) United States
(12) Patent Application Publication
(10) Pub. No.: US 2025/0026147 A1
(43) Pub. Date: Jan. 23, 2025

(54) WHEEL BEARING UNIT FOR A VEHICLE

(71) Applicant: Schaeffler Technologies AG & Co. KG, Herzogenaurach (DE)

(72) Inventors: Andreas Kaiser, Werneck (DE); Frank Eichelmann, Donnersdorf (DE)

(73) Assignee: Schaeffler Technologies AG & Co. KG, Herzogenaurach (DE)

(21) Appl. No.: 18/717,456

(22) PCT Filed: Dec. 5, 2022
(86) PCT No.: PCT/DE2022/100907

§ 371 Date: Jun. 7, 2024

(30) Foreign Application Priority Data
Jan. 4, 2022 (DE) 10 2022 100 133.4

(51) Int. Cl. B60B 27/00; F16C 33/78

(52) U.S. Cl. CPC B60B 27/0036; F16C 33/78; F16C 2326/02

(57) ABSTRACT

A wheel bearing unit for a motor vehicle includes a wheel bearing hub with a first spur toothing, a constant velocity joint with a second spur toothing, a radially pretensionable element and a conical peripheral surface. The radially pretensionable element is disposed in a recess and protrudes radially from the recess in an unstressed state. The conical peripheral surface is disposed radially opposite the radially pretensionable element in a partially assembled state of the wheel bearing unit. During assembly of the wheel bearing unit, the radially pretensionable element applies an axially acting force to the conical peripheral surface to brace the wheel bearing hub against constant velocity joint. A method for assembling the wheel bearing unit is also disclosed.

### CROSS-REFERENCE TO RELATED APPLICATIONS

This application is the United States National Phase of PCT Appln. No. PCT/DE2022/100907 filed Dec. 5, 2022, which claims priority to German Application No. DE102022100133.4 filed Jan. 4, 2022, the entire disclosures of which are incorporated by reference herein.

### TECHNICAL FIELD

The present disclosure relates to a wheel bearing unit for a drive train of a vehicle, in particular a motor vehicle, and to a method for assembling such a wheel bearing unit.

### BACKGROUND

Wheel bearing units for motor vehicles are known from the prior art in a variety of embodiments. In this regard, it is known to provide power transmission between a drive shaft and a wheel bearing hub via a radial or spur toothing. A spur toothing can be provided, for example, on a constant velocity joint or a cardan shaft that engages with a drive shaft of the motor vehicle. The spur toothing of the constant velocity joint can, in turn, engage with a correspondingly designed spur toothing of the wheel bearing hub so that a corresponding torque of the drive shaft can be transmitted to the wheel bearing hub.

The assembly of the wheel bearing unit is comparatively complex here, as the wheel bearing hub is usually first attached to a wheel carrier and then the constant velocity joint is inserted into the wheel carrier, wherein the connection between the wheel bearing hub and the constant velocity joint via the spur toothings is established in a blind assembly. As such, during the assembly of the constant velocity joint and the wheel bearing hub, it can happen that the teeth of the spur toothing of the constant velocity joint and the teeth of the spur toothing of the wheel bearing hub meet instead of meshing with one another. This means that the teeth of the spur toothing of the constant velocity joint do not engage in the tooth gaps of the spur toothing of the wheel bearing hub. When the constant velocity joint and the wheel bearing hub are braced in this so-called tooth-on-tooth position of the two spur toothings, the tooth heads of the two spur toothings are pressed onto one another and can only be brought into the so-called tooth-in-tooth position, in which the two spur toothings mesh, at a later point in time and using a comparatively large amount of force. This can lead to a loss of pretension force in the constant velocity joint/wheel bearing hub connection and/or damage to the spur toothings.

Various solutions are known in the prior art, in particular to prevent a reduction in the pretension force. For example, DE 10 2007 057 047 A1 discloses a method for assembling a wheel hub component with a shaft joint component connected thereto in a non-rotatable manner and a corresponding connection arrangement.

### SUMMARY

The present disclosure provides an improved wheel bearing unit for a vehicle, which, for example, can be assembled more easily.

A wheel bearing unit according to the disclosure for a drive train of a vehicle, in particular a motor vehicle, has a wheel bearing hub with a first spur toothing, a constant velocity joint of a drive joint with a second spur toothing, a circumferential, radially pretensionable element and a substantially conical peripheral surface. The radially pretensionable element is accommodated in a circumferential recess in such a way that, in an elastically unstressed state, it protrudes at least partially from the recess in the radial direction. In an at least partially assembled state of the wheel bearing unit, the conical peripheral surface is arranged opposite the radially pretensionable element in the radial direction. Here, the radially pretensionable element and the conical peripheral surface interact during assembly of the wheel bearing unit in such a way that an axially acting force is generated, which braces or pretensions the wheel bearing hub and the constant velocity joint against one another.

The radially pretensionable, circumferential element can, for example, be designed as ring-shaped, star-shaped or slotted when closed, i.e., as ring-shaped or star-shaped when open. Furthermore, the radially pretensionable, circumferential element can also be designed as non-circular, e.g., oval, drop-shaped, etc., wherein the radially pretensionable element can also be designed as closed or slotted, i.e., open, in these shapes. For example, a star-shaped and/or open radially pretensionable, circumferential element enables improved guidance in the recess and/or enables greater radial spreading. For example, the radially pretensionable element can be designed as a rubber ring, such as an O-ring. In addition, the radially pretensionable, circumferential element can, for example, be designed as a circlip, which can be made of a plastic or plastic mixture, or a metal or a metal alloy. The axially acting force can also be referred to as the axial pretension force.

Contact of the radially pretensionable element with the conical peripheral surface generates a radial force due to the elastically stressed state of the radially pretensionable element, which, in conjunction with the conical peripheral surface, generates an axially acting force in the assembly direction, thus bracing the wheel bearing hub and the constant velocity joint against one another. This means that the wheel bearing hub and the constant velocity joint cannot easily fall apart during assembly of the wheel bearing unit, even if the first and second spur toothing are in a tooth-on-tooth position. In this state, a tooth-in-tooth position of the first and second spur toothing can be achieved by a small rotational relative movement between the wheel bearing hub and the constant velocity joint. Due to the axially acting force, the wheel bearing hub and the constant velocity joint are then held in the tooth-in-tooth position, in which they can then be firmly braced together by means of a bracing element, for example a clamping screw.

Snapping the elastically pretensionable element into the conical peripheral surface can also make it less likely for the connection to become detached, as the elastically pretensionable element must be elastically deformed in a direction opposite to the assembly direction against the radial force, which can only be achieved by applying an external force.

In other words, a wheel bearing unit with a pretensioned snap-in device is proposed in order to produce a tooth-in-tooth assembly between the first spur toothing of the wheel bearing hub and the second spur toothing of the constant velocity joint. Furthermore, such a snap-in device requires little additional installation space, which is why the installation space requirement of the wheel bearing unit remains essentially unchanged.

According to one embodiment, the recess is provided on an outside diameter of the constant velocity joint and the conical peripheral surface is provided on an inside diameter of the wheel bearing hub, wherein the inside diameter of the wheel bearing hub is larger than the outside diameter of the constant velocity joint. Due to the recess on the outside diameter of the constant velocity joint, the radially pretensionable element is easy to assemble and can be designed as a circlip, for example. Alternatively, according to a further embodiment, the recess is provided on an inside diameter of the wheel bearing hub and the conical peripheral surface is provided on an outside diameter of the constant velocity joint, wherein the inside diameter of the wheel bearing hub is larger than the outside diameter of the constant velocity joint. The recess on the inside diameter of the wheel bearing hub further allows the use of an inexpensive O-ring as the radially pretensionable element.

According to one embodiment, the wheel bearing unit further has a constriction diameter which is designed to elastically deform the radially pretensionable element during the assembly of the wheel bearing unit in such a way that the radially pretensionable element snaps into the conical peripheral surface after passing through the constriction diameter. It can therefore be said that the constriction diameter is arranged upstream of the conical peripheral surface as viewed in the assembly direction. Furthermore, the constriction diameter is selected such that the radially pretensionable element undergoes at least a slight reduction in radial pretension after passing the constriction diameter and thus snaps into the conical peripheral surface.

According to one embodiment, the wheel bearing unit further has a tapering, e.g., inclined or conical, guide surface, which is arranged upstream of the conical peripheral surface in the axial direction as viewed in an assembly direction. The conical guide surface may be designed such that the radially pretensionable element is guided towards the constriction diameter along the conical guide surface. The conical guide surface enables the radially pretensionable element to be gradually deformed more elastically when the constant velocity joint is inserted into the wheel bearing hub, thus simplifying assembly, e.g., the correct contacting between the radially pretensionable element and the conical peripheral surface.

According to one embodiment, a trailing surface is arranged downstream of the conical peripheral surface as viewed in the assembly direction. The trailing surface is used to accommodate the radially pretensionable element after the assembly of the wheel bearing unit after the assembly of the wheel bearing hub and the constant velocity joint, for example.

According to a further embodiment, the trailing surface is formed as substantially cylindrical or substantially oppositely conical with respect to the conical peripheral surface. The cylindrical trailing surface can accommodate the radially pretensionable element in an elastically unstressed state, e.g., loosely, and prevents the radially pretensionable element from slipping out of the region between the inside diameter of the wheel bearing hub and the outside diameter of the constant velocity joint after the wheel bearing unit has been assembled. The oppositely conically shaped trailing surface can bring the radially pretensionable element, which is initially in an elastically unstressed state, back into an elastically stressed state and thus fix the elastically pretensionable element in its position during the final bracing of the wheel bearing hub and the constant velocity joint and thus prevent “rattling” caused by a loose radially pretensionable element in the operating state, for example.

According to one embodiment, an inclination of the conical peripheral surface is designed such that a self-locking effect is prevented during the assembly of the wheel bearing unit. This ensures that the elastically pretensionable element can move, e.g., slide, along the conical peripheral surface.

According to one embodiment, the recess is formed as an integral groove or slot. This means that the groove or slot is formed either on the inside diameter of the wheel bearing hub or on the outside diameter of the constant velocity joint. A groove or slot is easy and inexpensive to produce and requires no additional components.

According to one embodiment, the recess is at least partially, or completely, formed by a separate element arranged, e.g., fixed, on the inside diameter of the wheel bearing hub or on the outside diameter of the constant velocity joint. For example, the entire recess can be formed as a separate U-shaped ring that is pressed into the inside diameter of the wheel bearing hub or pressed onto the outside diameter of the constant velocity joint. Furthermore, the recess can also have an L-shaped ring that forms the recess together with a shoulder on the inside diameter of the wheel bearing hub or on the outside diameter of the constant velocity joint. The L-shaped ring can be pressed into the inside diameter of the wheel bearing hub or pressed onto the outside diameter of the constant velocity joint.

A further aspect of the disclosure relates to a method for assembling a wheel bearing unit according to the disclosure, wherein the method comprises the following steps:
inserting the outside diameter of the constant velocity joint into the inside diameter of the wheel bearing hub,
bringing the radially pretensionable element into contact with the conical peripheral surface,
generating an axial force, which pretensions the wheel bearing hub and the constant velocity joint against one another,
providing a form-fitting connection (tooth-in-tooth) between the first and second spur toothing, and
connecting/fastening the wheel bearing hub and/to the constant velocity joint with a connecting element/fastening element/bracing element.

The axial pretension is generated by snapping the radially pretensionable element into the conical peripheral surface, for example.

### BRIEF DESCRIPTION OF THE DRAWINGS

Further measures improving the disclosure are illustrated below together with the description of exemplary embodiments using the figures. In the drawings:

FIG. 1A shows a schematic partial representation of a wheel bearing arrangement according to one embodiment,

FIG. 1B shows a perspective view of a radially pretensionable element according to one embodiment,

FIG. 2A shows a schematic partial representation of a wheel bearing unit according to one embodiment,

FIG. 2B shows a schematic partial representation of a wheel bearing unit according to one embodiment,

FIG. 3 shows a schematic partial representation of a wheel bearing unit according to one embodiment,

FIG. 4 shows a schematic partial representation of a wheel bearing unit according to one embodiment,

FIG. 5 shows a schematic partial representation of a wheel bearing unit according to one embodiment, and

FIG. 6 shows a schematic representation of a method for assembling a wheel bearing unit according to one embodiment.

### DETAILED DESCRIPTION

The figures are only schematic in nature and serve only for understanding of the disclosure. Identical elements are provided with the same reference symbols.

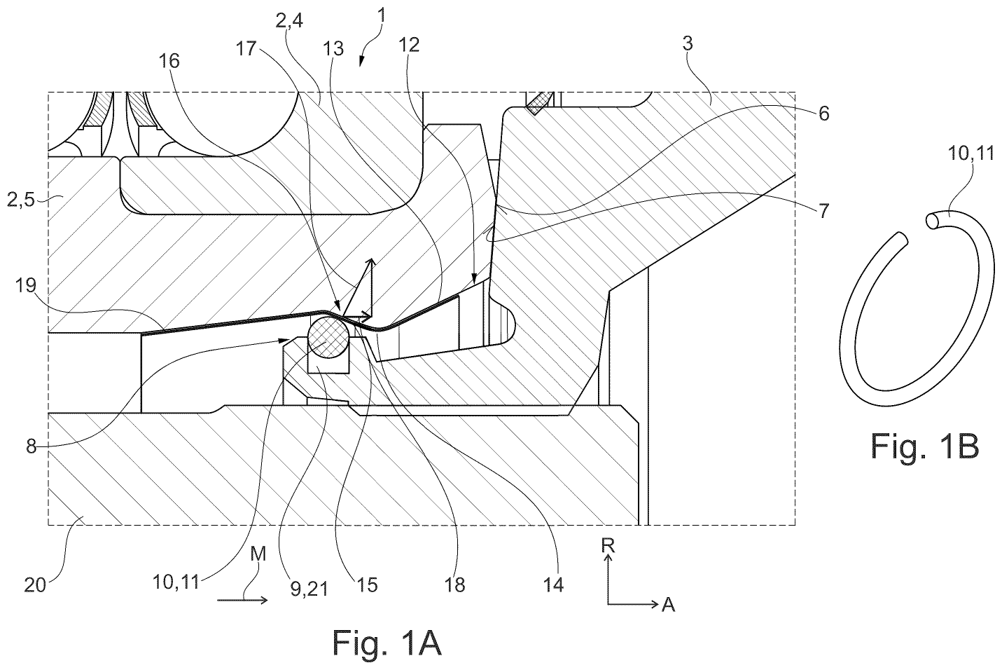

FIG. 1A and FIGS. 2A to 5 each show an exemplary, schematic partial representation of a wheel bearing unit 1 for a vehicle, having a wheel bearing 2 and a constant velocity joint 3 in a longitudinal section. The wheel bearing 2 has a rolling bearing 4 and a wheel bearing hub 5, on which the rolling bearing 4 is arranged in an axially fixed manner. The wheel bearing hub 5 further has a first spur toothing 6, which is in torque-transmitting engagement with a second spur toothing 7 on the constant velocity joint 3 in an assembled state of the wheel bearing unit 1.

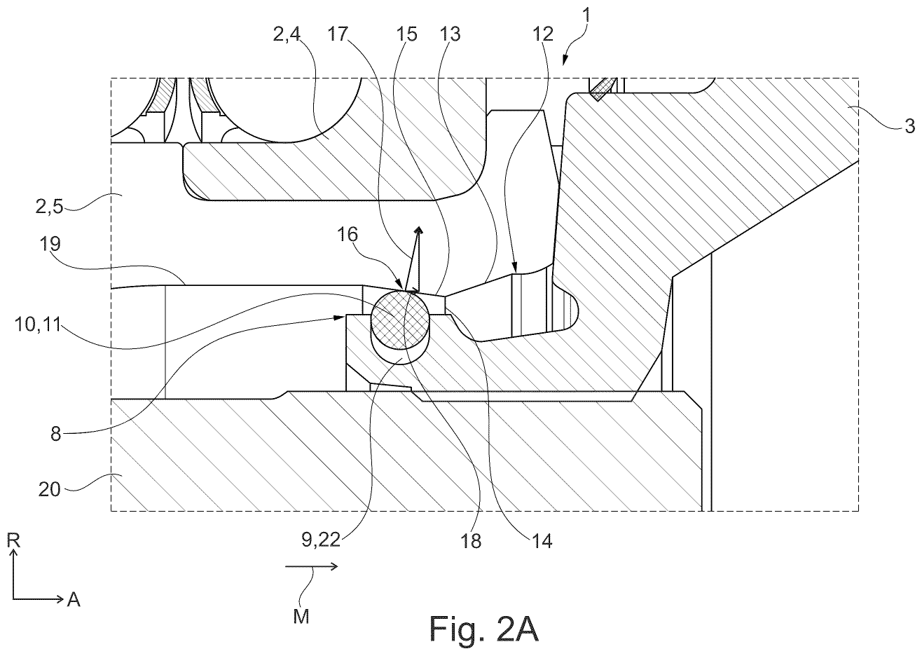

In FIG. 1A and in FIGS. 2a to 4, the constant velocity joint 3 further has a recess 9 on an outside diameter 8, in which a radially pretensionable element 10 is arranged in such a way that, in an elastically unstressed state, it protrudes at least partially outwards from the recess 9 in the radial direction R. In this regard, the recess 9 is designed in such a way that it can essentially completely accommodate a volume of the radially pretensionable element 10 in an elastically stressed state.

By way of example, the radially pretensionable element 10 is designed here as a circlip 11 (see FIG. 1B), which can be made from a plastic, a plastic mixture, a metal or a metal alloy, for example. The wheel bearing hub 5 has a guide surface 13, a constriction diameter 14 and a conical peripheral surface 15 on an inside diameter 12, wherein the constriction diameter 14 is smaller than the inside diameter 12 of the wheel bearing hub 5, but larger than the outside diameter 8 of the constant velocity joint 3.

The guide surface 13 is formed in an inclined, e.g., conical, manner such that the radially pretensionable element slides along the guide surface 13 when the constant velocity joint 3 is inserted into the wheel bearing hub 5 and is thus gradually elastically compressed. The gradual elastic compression of the radially pretensionable element 10 makes it easier to guide it through the constriction diameter 14. After passing the constriction diameter 14, the radially pretensionable element 10 expands outwards again in the radial direction until it comes into contact with the conical peripheral surface 15. Here, the conical peripheral surface 15 is designed in such a way that the cone tapers in the axial direction A towards the constriction diameter 14. This means that the radially pretensionable element 10 cannot transition to an elastically unstressed state after passing the constriction diameter 14, as a result of which a radial force 17 is generated in a contact region 16 between the radially pretensionable element 10 and the conical peripheral surface 15, which acts on the conical peripheral surface 15. Due to the conical, i.e., oblique in the longitudinal section, course of the conical peripheral surface 15, the radial force 17 acting perpendicularly on the conical peripheral surface 15 results in an axial force 18 acting in the axial direction A, which braces the wheel bearing hub 5 and the constant velocity joint 3 minimally or slightly against one another in an assembly direction M. The axial force 18 can also be referred to as the axial pretension force 18.

In this regard, the constriction diameter 14 and the conical peripheral surface 15 are arranged in the axial direction A in such a way that the radially pretensionable element 10 is already “snapped in”, so to speak, behind the constriction diameter 14 when the spur toothings 6, 7 are in a tooth-on-tooth position, and the axial force 18 is thus already generated. The axial force 18 causes the wheel bearing hub 5 and the constant velocity joint 3 to be braced against one another in the tooth-on-tooth position during the assembly of the wheel bearing unit 1 in such a way that the constant velocity joint 3 does not fall out of the wheel bearing hub 5 again. A tooth-in-tooth position, which can also be referred to as a tooth-in-gap position, can be produced by a rotational relative movement between the wheel bearing hub 5 and the constant velocity joint 3, wherein the axial force 18 is designed to axially pretension the wheel bearing hub 5 and the constant velocity joint 3 against one another also in the tooth-in-tooth position, thus preventing the constant velocity joint 3 from falling out of the wheel bearing hub 5 also in the tooth-in-tooth position.

Furthermore, the wheel bearing hub 5 has a trailing surface 19 which is arranged downstream of the conical peripheral surface 15 as viewed in the assembly direction M. The trailing surface 19 can either be formed as oppositely conical (see FIGS. 1A, 3 and 4) with respect to the conical peripheral surface 15 or substantially cylindrical (see FIGS. 2A and 2B). The trailing surface 19 is used to accommodate the radially pretensionable element 10 after the assembly of the wheel bearing unit 1, e.g., after the wheel bearing hub 5 and the constant velocity joint 3 have been braced by a bracing element 20, such as a clamping screw, and thus prevent the radially pretensionable element 10 from slipping out of the recess 9. For example, the oppositely conically shaped trailing surface 19 can elastically stress, in FIGS. 1A, 3 and 4, elastically compress, the radially pretensionable element 10 in such a way that the radially pretensionable element 10 is braced in the recess in such a way that it is essentially unable to move in the operating state of the wheel bearing unit 1. The substantially cylindrically designed trailing surface 19 (FIGS. 2A. 2B) prevents the radially pretensionable element 10 from slipping out of the recess 9, but the radially pretensionable element 10 can move between the cylindrical trailing surface 19 and the recess 9 and thus cause rattling in the operating state of the wheel bearing unit 1.

In FIGS. 1A, 2A and 2B, the recess 9 is integrally formed in one piece on the outside diameter 8 of the constant velocity joint 3 by way of example, wherein the recess is formed as a groove 21 in FIG. 1A and as a slot 22 in FIGS. 2A and 2B. Grooves and slots are easy and inexpensive to produce.

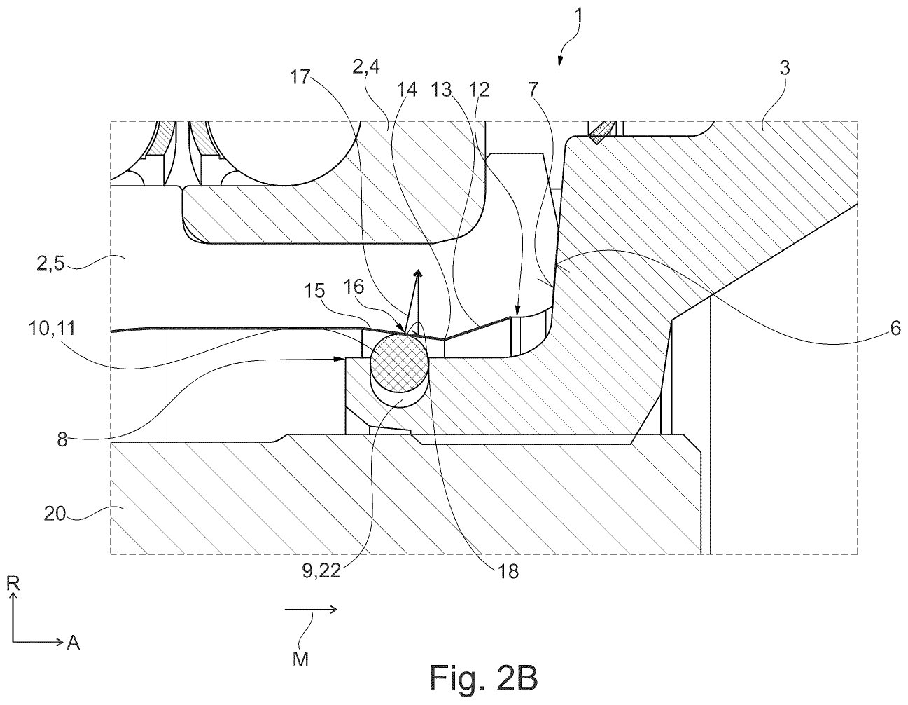

In FIG. 3, the recess 9 is designed as a separate U-shaped component 23, which is arranged on the outside diameter 8 of the constant velocity joint 3. For example, the component 23 can be pressed onto the outside diameter 8. The U-shaped component 23 is produced separately from the constant velocity joint 3 and can therefore be made of different materials. This makes it possible to customize the material of the recess 9.

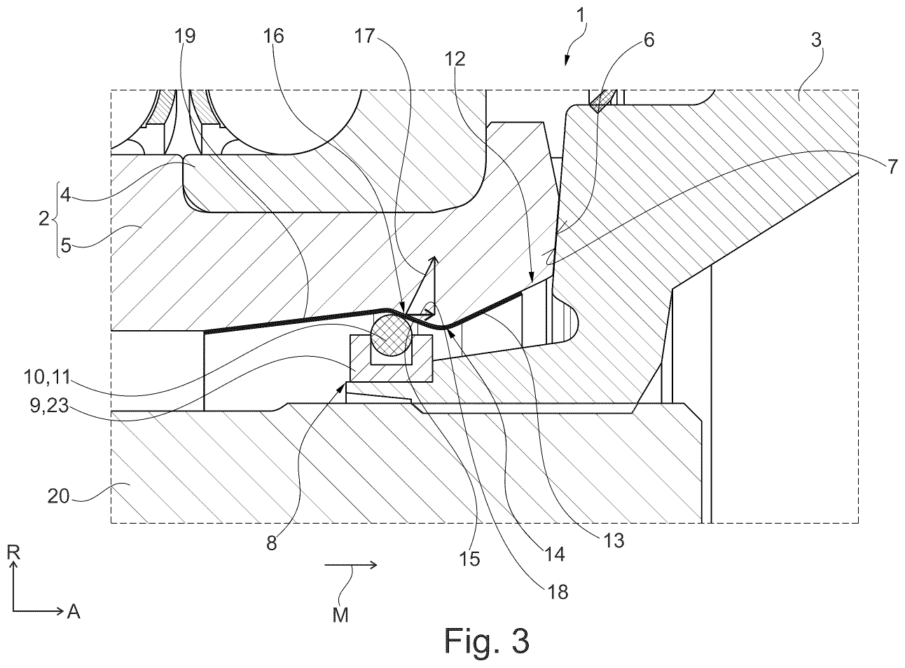

In FIG. 4, the recess 9 is formed as a combination of a radial shoulder 24, which is integrally formed in one piece on the outside diameter 8 of the constant velocity joint 3, and an L-shaped component 25. The L-shaped component 25 is arranged on the outside diameter 8 of the constant velocity joint 3, and may be pressed onto the outside diameter 8.

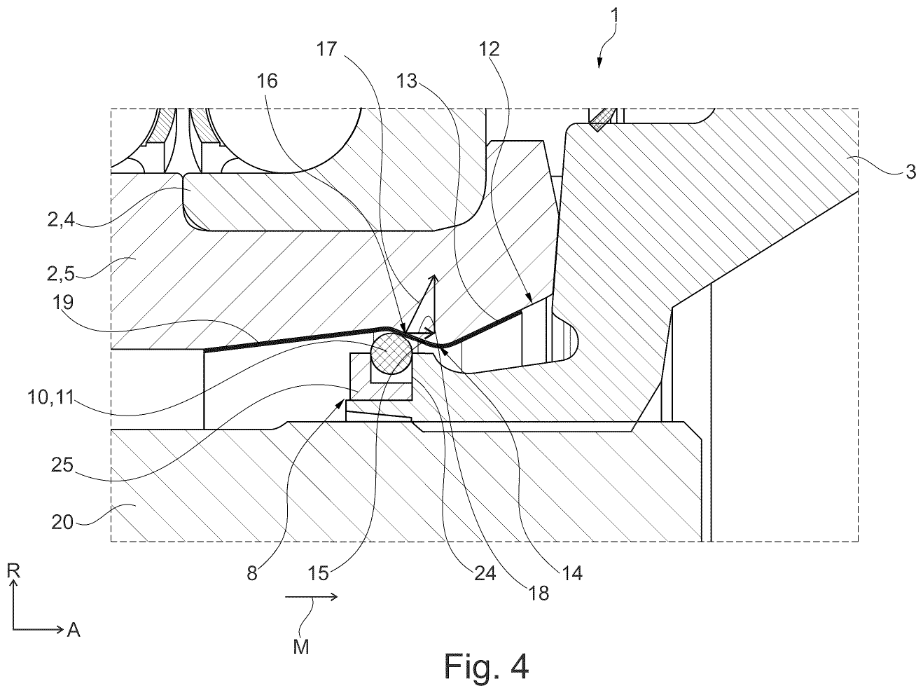

The exemplary embodiment of the wheel bearing unit 1 shown in FIG. 5 essentially differs from the embodiments described previously in that the recess 9 is arranged on the inside diameter 12 of the wheel bearing hub 5, and the conical peripheral surface 15 is arranged on the outside diameter 8 of the constant velocity joint 3. The interaction of the radially pretensionable element 10 with the conical peripheral surface 15 essentially corresponds to the interaction described with reference to FIGS. 1A and 2A to 4. This means that in the contact region 16 between the radially pretensionable element 10 and the conical guide surface 15, a radial force 26 acts perpendicularly on the conical peripheral surface 15, from which an axial force 27 is generated in the axial direction A, which braces the wheel bearing hub 5 and the constant velocity joint 3 against one another so that the constant velocity joint 3 can be prevented from falling out of the wheel bearing hub 5.

In FIG. 5, the constant velocity joint further has a guide surface 28, a constriction diameter 29 and a trailing surface 30, wherein the constriction diameter 29 protrudes radially inwards from the outside diameter 8. This means that the constriction diameter 29 is larger than the outside diameter 8 of the constant velocity joint 3, but smaller than the inside diameter of the wheel bearing hub 5. In FIG. 5, the trailing surface 30 is formed as substantially cylindrical. However, it is also conceivable that the trailing surface 30 is formed as oppositely conical with respect to the conical peripheral surface 15. Furthermore, the recess 9 is exemplarily designed as a U-shaped component 23. However, it is also conceivable to form the recess 9 integrally in one piece as a groove or as a slot on the inside diameter 12 of the wheel bearing hub 5, or as an L-shaped component 25 in combination with a radially inwardly protruding shoulder, which is integrally formed in one piece on the inside diameter 12 of the wheel bearing hub 5.

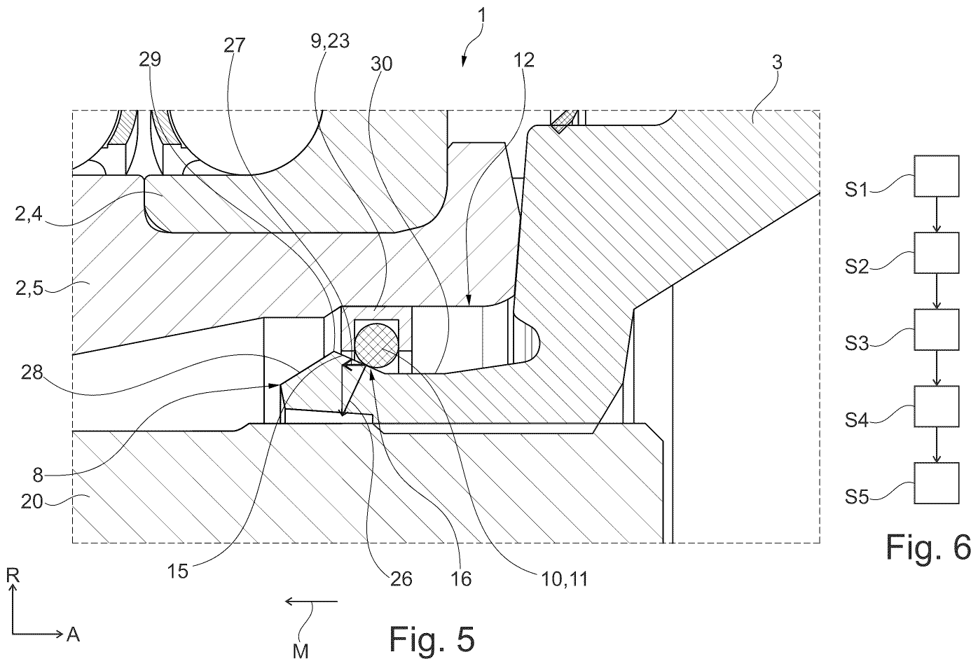

FIG. 6 shows a schematic representation of a method for assembling the wheel bearing unit 1 according to one embodiment. In a first step S1, the constant velocity joint 3 is inserted into the wheel bearing hub 5 in the axial direction A. In a step S2, the radially pretensionable element 10 is brought into contact with the conical peripheral surface 15. In a step S3, an axial force 18, 27 is generated, which pretensions the wheel bearing hub 5 and the constant velocity joint 3 against one another, e.g., in an assembly direction M. In a step S4, a form-fitting connection, e.g., a tooth-in-tooth position, is produced between the first and second spur toothing 6, 7, and in a step S5, the wheel bearing hub 5 and the constant velocity joint 3 are connected to one another, e.g., braced against one another, by means of a bracing element 20.

The disclosure is not restricted to the embodiments described above. Rather, deviations are also conceivable that are included within the scope of protection of the disclosure.

### Reference Numerals

1 Wheel bearing unit
2 Wheel bearing
3 Constant velocity joint
4 Rolling bearing
5 Wheel bearing hub
6 First spur toothing
7 Second spur toothing
8 Outside diameter
9 Recess
10 Radially pretensionable element
11 Circlip
12 Inside diameter
13 Guide surface
14 Constriction diameter
15 Conical peripheral surface
16 Contact region
17 Radial force
18 Axial force
19 Trailing surface
20 Bracing element
21 Groove
22 Slot
23 U-shaped component
24 Radial shoulder
25 L-shaped component
26 Radial force
27 Axial force
28 Guide surface
29 Constriction diameter
30 Trailing surface
R Radial direction
A Axial direction
M Assembly direction

1. A wheel bearing unit for a drive train of a vehicle comprising:
a wheel bearing hub with a first spur toothing,
a constant velocity joint of a drive joint with a second spur toothing,
a radially pretensionable element that is accommodated in a recess in such a way that, in an elastically unstressed state, it protrudes at least partially from the recess in a radial direction (R), and
a conical peripheral surface which, in an at least partially assembled state of the wheel bearing unit, is arranged opposite the radially pretensionable element in the radial direction (R),
wherein the radially pretensionable element and the conical peripheral surface interact during assembly of the wheel bearing unit in such a way that an axially acting force is generated, which braces the wheel bearing hub and the constant velocity joint against one another.

2. The wheel bearing unit according to claim 1,
wherein the recess is provided on an outside diameter of the constant velocity joint and the conical peripheral surface is provided on an inside diameter of the wheel bearing hub, and the inside diameter of the wheel bearing hub is larger than the outside diameter of the constant velocity joint; or
wherein the recess is provided on an inside diameter of the wheel bearing hub and the conical peripheral surface is provided on an outside diameter of the constant velocity joint.

3. The wheel bearing unit according to claim 1, further comprising a constriction diameter which is designed to elastically deform the radially pretensionable element during the assembly of the wheel bearing unit in such a way that the radially pretensionable element snaps into the conical peripheral surface after passing through the constriction diameter.

4. The wheel bearing unit according to claim 1, further comprising a tapering guide surface which is arranged upstream of the conical peripheral surface in an axial direction (A) as viewed in an assembly direction (M).

5. The wheel bearing unit according to claim 1, wherein a trailing surface is formed downstream of the conical peripheral surface as viewed in an assembly direction (M).

6. The wheel bearing unit according to claim 5, wherein the trailing surface is formed as substantially cylindrical or substantially oppositely conical with respect to the conical peripheral surface.

7. The wheel bearing unit according to claim 1, wherein an inclination of the conical peripheral surface is formed such that a self-locking effect is prevented during the assembly of the wheel bearing unit.

8. The wheel bearing unit according to claim 1, wherein the recess is formed as an integral groove or slot on an inside diameter of the wheel bearing hub or on an outside diameter of the constant velocity joint.

9. The wheel bearing unit according to claim 1, wherein the recess is at least partially formed by a separate element arranged on an inside diameter of the wheel bearing hub or on an outside diameter of the constant velocity joint.

10. A method for assembling a wheel bearing unit according to claim 1, comprising:
inserting the constant velocity joint into the wheel bearing hub,
bringing the radially pretensionable element into contact with the conical peripheral surface,
generating an axial force, which braces the wheel bearing hub and the constant velocity joint against one another,
producing a form-fitting connection between the first and second spur toothing, and
connecting the wheel bearing hub and the constant velocity joint with a bracing element.

11. A wheel bearing unit for a motor vehicle, comprising:
a wheel bearing hub comprising a first spur toothing;
a constant velocity joint comprising a second spur toothing;
a radially pretensionable element disposed in a recess, the radially pretensionable element protruding radially from the recess in an unstressed state; and
a conical peripheral surface disposed radially opposite the radially pretensionable element in a partially assembled state of the wheel bearing unit, wherein, during assembly of the wheel bearing unit, the radially pretensionable element applies an axially acting force to the conical peripheral surface to brace the wheel bearing hub against constant velocity joint.

12. The wheel bearing unit of claim 11, wherein:
an inside diameter of the wheel bearing hub is larger than an outside diameter of the constant velocity joint; and
the recess is disposed on the outside diameter of the constant velocity joint and the conical peripheral surface is disposed on the inside diameter of the wheel bearing hub; or
the recess is disposed on the inside diameter of the wheel bearing hub and the conical peripheral surface is disposed on the outside diameter of the constant velocity joint.

13. The wheel bearing unit of claim 11 further comprising a constriction diameter arranged to elastically deform the radially pretensionable element, wherein, during assembly of the wheel bearing unit, the radially pretensionable element snaps onto the conical peripheral surface after passing through the constriction diameter.

14. The wheel bearing unit of claim 11, further comprising a tapering guide surface arranged axially upstream of the conical peripheral surface as viewed in an assembly direction of the wheel bearing unit.

15. The wheel bearing unit of claim 11, further comprising a trailing surface formed downstream of the conical peripheral surface as viewed in an assembly direction of the wheel bearing unit.

16. The wheel bearing unit of claim 15, wherein the trailing surface is:
substantially cylindrical; or
substantially conical in a direction opposite the conical peripheral surface.

17. The wheel bearing unit of claim 11, wherein an inclination of the conical peripheral surface is selected to prevent self-locking of the radially pretensionable element on the conical peripheral surface during assembly of the wheel bearing unit.

18. The wheel bearing unit of claim 11, wherein the recess is formed as an integral groove or slot on an inside diameter of the wheel bearing hub or on an outside diameter of the constant velocity joint.

19. The wheel bearing unit of claim 11, wherein at least a portion of the recess is formed by a separate element arranged on an inside diameter of the wheel bearing hub or on an outside diameter of the constant velocity joint.
